(19) United States
(12) Patent Application Publication
(10) Pub. No.: US 2006/0021449 A1
(43) Pub. Date: Feb. 2, 2006

(54) Coriolis mass flowmeter and method for producing a coriolis mass flowmeter

(76) Inventors: Youssif A. Hussain, Northampton (GB); Chris N. Rolph, Northampton (GB); Neil Harrisson, Northampton (GB)

Correspondence Address: CESARI AND MCKENNA, LLP, 88 BLACK FALCON AVENUE, BOSTON, MA, 02210, US

(21) Appl. No.: 11/152,448

(22) Filed: Jun. 14, 2005

(30) Foreign Application Priority Data
Jul. 29, 2004 (DE) 10 2004 036 927.5
Jul. 30, 2004 (DE) 10 2004 037 370.1

(51) Int. Cl. G01F 1/84

(52) U.S. Cl. 73/861.357

(57) ABSTRACT

A Coriolis mass flowmeter features a measuring tube for guiding a flowing medium an oscillation-generating system with an oscillator for stimulating the oscillation of the measuring tube, and an oscillation-sensing system with an oscillation sensor for capturing the oscillations of the measuring tube. A first companion element is positioned opposite the oscillation-generating system at the same longitudinal distance of the measuring tube and a second companion element is positioned opposite the oscillation-sensing system at the same longitudinal distance on the measuring tube, with the mass of the first companion element corresponding to the mass of the oscillation-generating system and the mass of the second companion element corresponding to the mass of the oscillation-sensing system. The result is a Coriolis mass flowmeter with a high measuring accuracy. A method for producing the flowmeter is also disclosed.

### BACKGROUND OF THE INVENTION

1. Field of the Invention

This invention relates to a Coriolis mass flowmeter incorporating a measuring tube for guiding a flowing medium, an oscillation-generating system with an oscillator lator serving to cause the measuring tube to vibrate, and an oscillation-sensing system with an oscillation sensor serving to capture the vibrations of the measuring tube. The invention further relates to a method for producing a Coriolis mass flowmeter that incorporates a measuring tube for guiding a flowing medium, an oscillation-generating system with an oscillator serving to cause the measuring tube to vibrate, and an oscillation-sensing system with an oscillation sensor serving to capture the vibrations of the measuring tube.

2. Background Information

A Coriolis mass flowmeter as defined above has been described for instance in WO 95/16897 A2. The Coriolis mass flowmeter according to that document employs the concept of oscillatory stimulation of the circumference of the measuring tube, producing vibrations that cause the diameter of the measuring tube to undergo vibration-induced geometric variations at least in the vibration-stimulating region. WO 01/92833 A1 describes a Coriolis mass flowmeter with similar stimulation of radial vibration of the measuring tube. As a particular feature of that latter Coriolis mass flowmeter the wall thickness of the measuring tube is substantially less than the radius of the measuring tube, which greatly facilitates the generation of radial vibrations and the concomitant deformation of the outer surface of the measuring tube.

Moreover, the length of the measuring tube in that Coriolis mass flow-meter is at least of the same order of magnitude as the radius of the measuring tube. The Coriolis mass flowmeter described in WO 01/92833 A1 thus features a measuring tube which due to its short dimension and its large inner diameter restricts the flow of the medium to a minor extent only, for correspondingly marginal interference with the flow in the pipeline in which the Coriolis mass flowmeter is installed.

The problem with these prior-art Coriolis mass flowmeters, however, is the unsatisfactory measuring accuracy attainable with them which, in particular, requires frequent recalibration.

### SUMMARY OF THE INVENTION

It is therefore the objective of this invention to introduce a Coriolis mass flowmeter, and a method for producing such a Coriolis mass flowmeter, by means of which a high degree of measuring accuracy is attainable.

Based on the Coriolis mass flowmeter concept described above, this objective is achieved by providing a first companion element opposite the oscillation-generating system at the same longitudinal distance on the measuring tube, by further providing a second companion element opposite the oscillation-sensing system at the same longitudinal distance on the measuring tube, by having the mass of the first companion element correspond to the mass of the oscillation-generating system and by having the mass of the second companion element correspond to the mass of the oscillation-sensing system, with at least one companion element featuring a balancing counter-weight.

One inventive aspect is the concept of positioning opposite the oscillation-generating system and, respectively, the oscillation-sensing system, at the same longitudinal distance on the measuring tube, a companion element whose matching mass produces a balanced measuring tube. As another inventive aspect, at least one companion element features a balancing counterweight. In this case, and for the purpose of the following description, the term counterweight refers to a passive weight as distinguished from an oscillator or an oscillation sensor, having no active effect on the measuring tube except for its weight.

In a preferred embodiment of the invention, at least one additional oscillation-generating system with an oscillator for causing the measuring tube to vibrate and/or an additional oscillation-sensing system with an oscillation sensor for capturing the vibrations of the measuring tube may be provided, each with a companion element whose mass corresponds to that of the oscillation-generating system or, respectively, the oscillation-sensing system and which is positioned opposite the oscillation-generating system or oscillation-sensing system at the same longitudinal distance on the measuring tube. In other words, the basic inventive concept also applies if and when several oscillation-generating systems, each with an oscillator, and/or several oscillation-sensing systems, each with an oscillation sensor, are incorporated. The significant characteristic lies in the fact that, in each case, a companion element having the same mass as the oscillation-generating system or, respectively, the oscillation-sensing system is positioned opposite the latter, producing a balanced measuring tube.

It is basically possible for the oscillation-generating system and for the 5 oscillation-sensing system to consist of only one oscillator or, respectively, one oscillation sensor without any additional components. In a preferred embodiment of the invention, however, at least one oscillation-generating system and/or at least one oscillation-sensing system is provided with an added weight. Again, such added weight is in the form of a purely passive element. Not only does this permit the balancing of the measuring ing tube by selecting companion elements whose mass corresponds to the mass of the respective oscillator or oscillation sensor, but it is also possible to define the weight bearing on the site of the oscillation-generating system or oscillation-sensing system and thus to predefine the individual opposite weights.

Specifically, it is possible to select weights that cause only a minimal oscillation loss. It has been found that the oscillation loss in the vibration of the measuring tube is a function of the mass of the oscillation-generating system and the oscillation-sensing system and its respective companion element, meaning that to a certain extent the oscillation loss can be compensated for by adjusting that mass. By minimizing the oscillation loss when the measuring tube is vibrating, the oscillation energy remains in the measuring tube and does not, or only to a negligible degree, spill over into the pipeline system in which the Coriolis mass flowmeter is installed.

This has several advantages. For one, a small oscillation loss means that a correspondingly smaller amount of excitation energy will suffice to operate the Coriolis mass flowmeter. For another, vibrations that are transferred from the measuring tube into the pipeline system will not be retroreflected, so as to interfere with the basic mass-flow measurement that involves the precise phase-locked acquisition of measuring-tube oscillations. Specifically, retroreflections of that nature affect the stability of the zero point as well as the sensitivity of the Coriolis mass flowmeter.

There are various ways in which the companion elements can be configured. In a preferred embodiment of the invention, however, all companion elements are provided with a counterweight or, more specifically, are constituted of such a counterweight In terms of its mass, each counterweight is adjusted to match the mass of the opposite oscillation-generating system or oscillation-sensing system. Then again, in another preferred embodiment of the invention, at least one companion element encompasses next to the counterweight an oscillator or an oscillation sensor. Specifically, an oscillation-generating system may be positioned opposite a companion element that includes an oscillation sensor and an oscillation-sensing system may be positioned opposite a companion element that includes an oscillator.

In general, there are numerous possible approaches for configuring and energizing the measuring tube of the Coriolis mass flowmeter. As indicated further above, the Coriolis mass flowmeter here described lends itself particularly well to the type of operation in which radial oscillations of the measuring tube are produced, meaning vibrations that cause a geometric variation of the cross-sectional profile of the measuring tube while in operation. In this context, a preferred embodiment of the invention provides for the measuring tube to feature a wall sufficiently thin in relation to its radius to permit easy generation and acquisition of its radial vibrations. It is particularly preferable to keep the wall thickness of the measuring tube smaller by a factor of 50 than the radius of the measuring tube. It is also especially desirable for the wall thickness to be less than or equal to 0.5 mm and preferably smaller than or equal to 0.25 mm.

To minimize the flow restriction through the Coriolis mass flowmeter, a preferred embodiment of the invention also provides for the length of the measuring tube to be of the order of magnitude of the radius of the measuring tube. This is possible especially because the measuring tube does not vibrate in all directions for instance like a guitar string. Instead, the measuring tube vibrates only in the radial direction, causing the circumferential surface of the measuring tube to deform, facilitated by the thin wall of the measuring tube. Finally, in a preferred embodiment of the invention, the ratio between the length of the measuring tube and the radius of the measuring tube is smaller than or equal to 6:1 and preferably smaller than or equal to 4:1.

In preferred embodiments of the invention, the measuring tube features at both ends a coupling sleeve for connecting the measuring tube to a pipeline system, with the sleeves designed to permit a “soft” coupling of the measuring tube to the pipeline. Specifically, such “soft” coupling of the measuring tube to the pipeline is achieved in that the sleeves are in the form of bellows. This largely eliminates the transfer of vibrations, if there were to be any such transfer at all in the Coriolis mass flowmeter according to the invention, from the measuring tube of the Coriolis mass flowmeter into the pipeline system with a potentially resulting retroreflection of spurious oscillations into the measuring tube.

Moreover, it will be helpful for the vibrational decoupling of the measuring tube of the Coriolis mass flowmeter from the pipeline system when, according to a preferred configuration of the invention, both ends of the measuring tube are provided with a terminal mass which terminal mass preferably extends around the perimeter, specifically in annular form, of the measuring tube.

The method according to this invention for producing a Coriolis mass flowmeter, based on the method first above mentioned, is characterized in that a first companion element is provided and positioned opposite the oscillation-generating system at the same longitudinal distance on the measuring tube, that a second companion element is positioned opposite the oscillation-sensing system at the same longitudinal distance on the measuring tube, that the mass of the oscillation-generating system and the mass of the oscillation-sensing system are variably selected, that the mass of the first companion element is adjusted to correspond to the mass of the oscillation-generating system, and that the mass of the second companion element is so selected as to correspond to the mass of the oscillation-sensing system, respectively gauged for a predefined excitation frequency of the measuring tube at which the oscillation loss of the mass of the oscillation-generating system and the oscillation-sensing system is minimized.

Thus, as the Coriolis mass flowmeter is produced, the invention provides for the testing of different masses of the oscillation-generating system and the oscillation-sensing system for a determination of the mass at which the oscillation-generating system and, respectively, the oscillation-sensing system exhibit the lowest oscillation loss. Of course, in the process, the mass of the associated companion element is adjusted as well, so that the mass of the companion element matches the mass of the oscillation-generating system or oscillation-sensing system opposite which it is positioned.

In this connection, it is important to point out that varying the mass can be performed by experimentation, i.e. on the measuring tube of the Coriolis mass flowmeter itself, but that it is also possible to simulate the parameters of the measuring tube of the Coriolis mass flowmeter with the aid of a model and numerical methodology, for instance employing a computer program.

The determination of the mass of the oscillation-generating system and the oscillation-sensing system at which the lowest oscillation loss is obtained can be made in various ways. According to a preferred implementation of the invention, the determination of the mass of the oscillation-generating system and the oscillation-sensing system at which the lowest oscillation loss is obtained is made by measuring the mass of the oscillation-generating system and, respectively, of the oscillation-sensing system at which the flattest oscillation amplitude is achieved at the ends of the measuring tube.

According to an alternative preferred implementation of the invention, the determination of the mass of the oscillation-generating system and the oscillation-sensing system at which the lowest oscillation loss is obtained is made by measuring the mass of the oscillation-generating system and, respectively, of the oscillation-sensing system at which the lowest excitation energy is needed for obtaining a predefined oscillation amplitude.

In a preferred implementation of the invention, the predefined excitation frequency selected for the measuring tube is a resonance frequency of the measuring tube, preferably when a medium is flowing through the measuring tube.

Moreover, according to a preferred implementation of the invention, the mass of the oscillation-generating system and/or the mass of the oscillation-sensing system is varied by adding an extra weight to the oscillation-generating system or oscillation-sensing system. In other words, adding extra weights of various sizes leads to a correspondingly varied mass of the oscillation-generating system or oscillation-sensing system. Of course, the mass of the respectively associated companion element must be adjusted accordingly. This approach can be used when one single oscillation-generating system and/or one single oscillation-sensing system is installed. Instead, the method according to the invention can be applied equally well when several oscillation-generating systems and/or several oscillation-sensing systems, each with corresponding companion elements, are employed.

There are numerous different ways in which the Coriolis mass flowmeter according to the invention and the novel method for producing such a Coriolis mass flowmeter can be configured and further enhanced. In this context, attention is invited to the dependent claims, as well as to the following description of preferred embodiments of the invention with reference to the accompanying drawings.

### BRIEF DESCRIPTION OF THE DRAWINGS

In the drawings:

FIG. 1 is a schematic illustration showing the design of a Coriolis mass flowmeter according to a first preferred embodiment of the invention, and

FIG. 2 is a schematic illustration showing the design of a Coriolis mass flowmeter according to a second preferred embodiment of the invention.

### DETAILED DESCRIPTION OF AN ILLUSTRATIVE EMBODIMENT

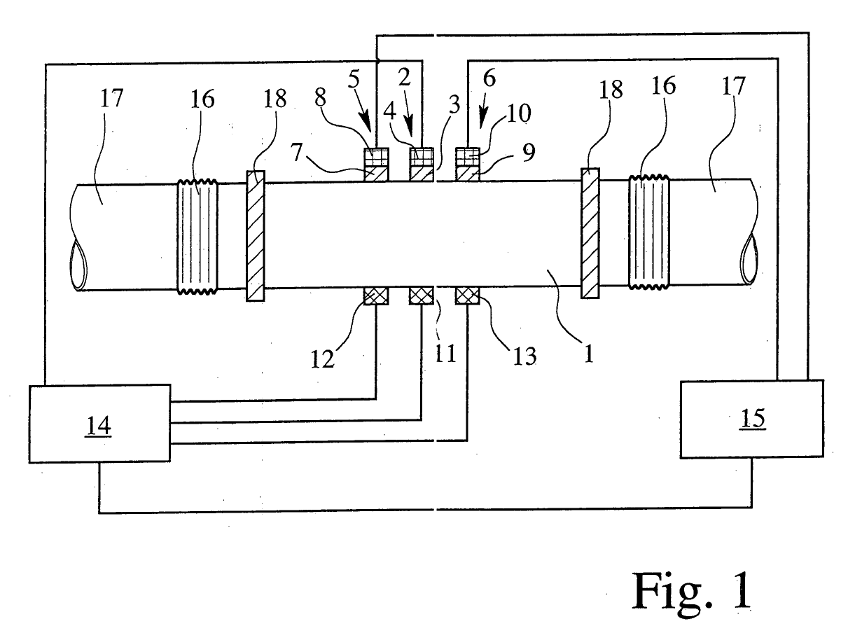

The Coriolis mass flowmeter schematically illustrated in FIG. 1 incorporates a measuring tube 1 through which, when the Coriolis mass flowmeter is in operation, tion, flows a medium, not shown. The oscillation of the measuring tube 1 is activated by an oscillation-generating system 2 that includes an oscillator 3, positioned precisely in the center of the measuring tube 1. In addition to the oscillator 3, the oscillation-generating system 2 includes an extra weight 4. Viewed in the longitudinal direction of the measuring tube 1, a first oscillation-sensing system 5 and a second oscillation-sensing system 6 are offset relative to the oscillation generating system 2. The first oscillation-sensing system 5 includes an oscillation sensor 7 and an extra weight 8 while the second oscillation-sensing system 6, on its part, includes an oscillation sensor 9 and an extra weight 10. It should be mentioned that FIG. 1 is strictly a schematic diagram and does not necessarily imply that the arrangement of the extra weights 4, 8, 10 relative to the oscillator 3 and the oscillation sensors 7, 9 must be as illustrated.

The first oscillation-sensing system 5 and the second oscillation-sensing system 6 are each positioned at the same distance from the oscillation-generating system 2, and the oscillation-generating system 2, the first oscillation-sensing system 5 and the second oscillation-sensing system 6 are all positioned along a line that extends parallel to the longitudinal axis of the measuring tube 1.

Located at 180° opposite the oscillation-generating system 2, the first oscillation-sensing system 5 and the second oscillation-sensing system 6, at the same longitudinal distance on the measuring tube, are companion elements 11, 12 13, specifically the companion element 11 being opposite the oscillation-generating system 2, the companion element 12 being opposite the first oscillation-sensing system 5 and the companion element 13 being opposite the second oscillation-sensing system 6. In this case, the mass of the companion element 11 matches the mass of the oscillation-generating system, the mass of the companion element 12 matches the mass of the first oscillation-sensing system 5 and the mass of the companion element 13 matches the mass of the second oscillation-sensing system 6, meaning that the mass of a companion element 11, 12, 13 is composed of the mass of the oscillator 3 or, respectively, of the oscillation sensor 7, 9 and the mass of the extra weight 4, 8 or 10. The result is not only a balanced measuring tube 1 by virtue of the identical mass of the mutually opposite components but also, due to the specific mass selected, an optimized oscillation pattern of the measuring tube 1, an oscillation pattern that minimizes the transfer of vibrations from the measuring tube 1 to the pipeline system 17 in which the measuring tube 1 is installed.

To obtain this optimized installation of the measuring tube 1 of the Coriolis mass flowmeter according to the first embodiment of the invention in terms of its oscillation pattern, the procedure to be applied in the production of the Coriolis mass flowmeter is as follows: in configuring the oscillation-generating system 2, the first oscillation-sensing system 5 and the second oscillation-sensing system 6, each with its companion element 11, 12, 13, their respective mass is variably modified. Using different masses at a predefined excitation frequency of the measuring tube 1, that being its first resonance frequency as the medium flows through it, this method allows for the determination of the mass at which the oscillation loss is lowest.

Generally, one will find that an optimal oscillation pattern is not obtained merely by assigning to the oscillator 3 and the oscillation sensors 7, 9 a companion element 11, 12, 13 whose mass fully matches the mass of the oscillator 3 or of the oscillation sensor 7, 9, respectively. Instead, adding an extra weight 4 at the point of the oscillator 3 and extra weights 8, 10 at the respective location of the oscillation sensors 7, 9 will often result in a better oscillation pattern in terms of the oscillation-energy economy within the measuring tube 1. In this connection, the extra weights 4, 8, 10 are preferably positioned in such fashion that the individual center of mass of the oscillation-generating system consisting of the oscillator and the extra weight 4, of the first oscillation-sensing system 5 consisting of the oscillation sensor 7 and the extra weight 8, and of the second oscillation-sensing system 6 consisting of the oscillation sensor 9 and the extra weight 10, when compared to the mere placement of the oscillator 3, the oscillation sensor 7 and the oscillation sensor 9, will remain at the same longitudinal distance along the measuring tube 1.

During the measuring operation of the Coriolis mass flowmeter, the oscillator 3, activated by an oscillation stimulation control device, generates radial vibrations of the measuring tube 1. This is accomplished with a measuring tube 1 whose wall is sufficiently thin in proportion to its radius to allow radial oscillations of the measuring tube 1 to be generated by the oscillator 3 and captured by the oscillation sensors 7, 9 while also permitting the collection of Coriolis oscillations. Specifically, the wall thickness of the measuring tube 1 is smaller by a factor of 50 than the radius of the measuring tube 1, with that wall thickness of the measuring tube 1 preferably being less than or equal to 0.5 mm. It is thus possible, as can be seen in FIG. 1, to arrive at a length of the measuring tube 1 short enough to be of the order of magnitude of the radius of the measuring tube 1. The oscillation sensors 7, 9 serve the usual purpose of measuring the mass flow rate by sending the signals captured to an evaluation device 15 in which a phase-sensitive signal analysis is performed.

The Coriolis mass flowmeter according to the first preferred embodiment of the invention, described above has additional features designed to improve its measuring accuracy and reduce any susceptibility to malfinction. Specifically, the measuring tube 1 connects to the pipeline system 17, in which the Coriolis mass flowmeter is installed, by way of couplings 16 in the form of bellows, which makes for a “soft” connection 10 tion between the measuring tube 1 and the pipeline system 17. The result is a virtual vibrational decoupling of the measuring tube 1 from the pipeline system 17, if in fact there were any residual possibility of vibrations being transferred from the measuring tube 1 to the pipeline system 17, which would have posed the problem of vibrations being retroreflected into the measuring tube 1.

Moreover, in the first preferred embodiment of the invention, the measuring tube 1 is provided at both ends with a circumferential, annular terminal mass 18. In practical application, it has been found that this terminal mass 18 significantly contributes to a further vibrational isolation of the measuring tube 1 from the pipeline system 17. The combination of the bellows-type couplings 16 and the terminal mass 18 creates a frequency filter that significantly reduces any vibrational interaction with the pipeline system 17. Apart from that, a balanced measuring tube provided with an increased mass by virtue of extra weights 4, 8, 10 and corresponding companion elements 11, 12, 13, as explained above, essentially eliminates the asymmetric oscillations that have plagued conventional Coriolis mass flowmeters.

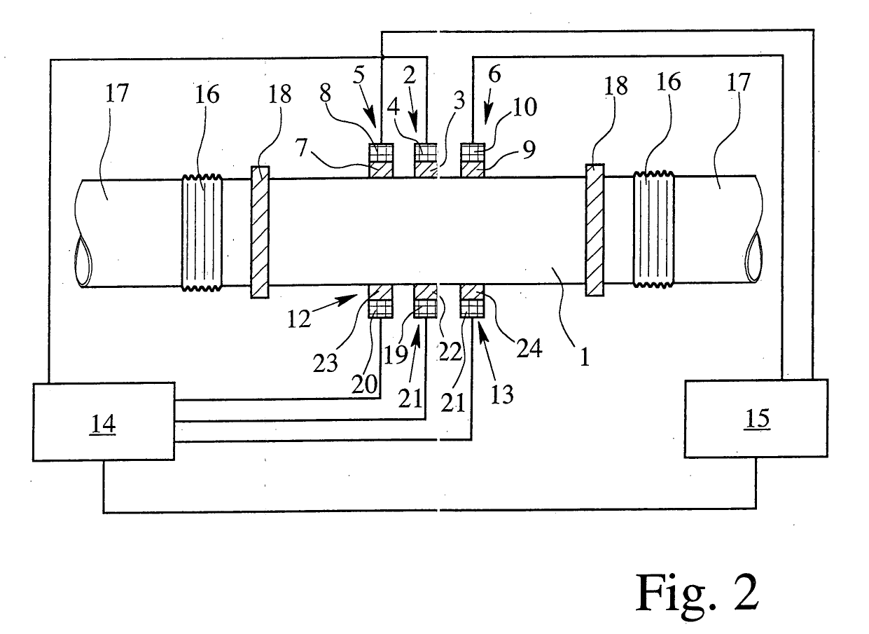

FIG. 2 illustrates a second preferred embodiment of the invention. The configuration of the Coriolis mass flowmeter in that figure is essentially identical to that of the Coriolis mass flowmeter according to the first preferred embodiment except for the fact that the companion elements 11, 12, 13 are not strictly passive, i.e. they are not merely counterweights. Instead, the companion elements 11, 12, 13 include, in addition to a counterweight 19, 20, 21, an oscillation sensor 22 or an oscillator 23, 24. Specifically, positioned opposite the oscillation-generating system 2 is the companion element 11 that consists of the oscillation sensor 22 and the counterweight 19, and positioned opposite the first oscillation-sensing system 5 is the second companion element 12 that consists of the counterweight 20 and the oscillator 23, while opposite the second oscillation-sensing system 6 the third companion element 13 is located, consisting of the counterweight 21 and the oscillator 24.

Adding the oscillation sensor 22 and the oscillator 23, 24 permits the following: the oscillation signal collected by the oscillation sensor 22 is fed to the oscillation stimulation control device 14 that activates the oscillation stimulation of the measuring tube 1 by triggering the oscillation of the oscillator 3 on the other side of the measuring tube 1. The particular positioning of the oscillation sensor 22 at the same longitudinal distance on the measuring tube 1 directly opposite the oscillator 3 that is essentially responsible for stimulating the oscillation of the measuring tube 1 enables the oscillation sensor 22 to capture a feedback signal that can be used in the oscillation stimulation control device 14 for activating the oscillator 3 for instance by tracking the excitation frequency to a temperature-dependent resonance frequency of the measuring tube by means of a phase-locked loop (PLL).

The additional oscillators 23, 24 also make it possible to stimulate the measuring tube 1 in another mode beyond the excitation mode, that being for instance the Coriolis mode. It permits the real-time determination of characteristic parameters such as sensitivity and/or the zero point of the Coriolis mass flowmeter as basically described for instance in DE 10002635 A1. That document describes the all-around vibration of the measuring tube 1 of the Coriolis mass flowmeter, like that of a guitar string, whereas in the case here described, the idea is to generate radial vibrations of the measuring tube 1. However, the basic principles of the method described in DE 10002635 A1 can easily be transferred to this embodiment example as well.

What is claimed is:

1. A coriolis mass flowmeter incorporating a measuring tube for guiding a flowing medium, an oscillation-generating system with an oscillator serving to cause the measuring tube to oscillate, and an oscillation-sensing system with an oscillation sensor serving to capture the oscillations of the measuring tube, wherein a first companion element is provided and positioned opposite the oscillation-generating system at the same longitudinal distance on the measuring tube, a second companion element is provided and positioned opposite the oscillation-sensing system at the same longitudinal distance on the measuring tube, the mass of the first companion element matches the mass of the oscillation-generating system and the mass of the second companion element matches the mass of the oscillation-sensing system, with at least one companion element including a counterweight:

2. The Coriolis mass flowmeter as in claim 1, and further including at least one additional oscillation-generating system including an oscillator for stimulating the oscillations of the measuring tube and/or an additional oscillation-sensing system including an oscillation sensor for capturing the oscillations of the measuring tube, each additional system being equipped with a companion element whose mass corresponds to the mass of the oscillation-generating system or, respectively, to the mass of the oscillation-sensing system and which is positioned opposite the oscillation-generating system or, respectively, the oscillation-sensing system at the same longitudinal distance on the measuring tube.

3. The Coriolis mass flowmeter as in claim 1 or 2, wherein at least one oscillation-generating system and/or at least one oscillation-sensing system is provided with an extra weight.

4. The Coriolis mass flowmeter as in claim 1 or 2, wherein each companion element is provided with a counterweight.

5. The Coriolis mass flowmeter as in claim 4, wherein at least one companion element includes an oscillator or an oscillation sensor.

6. A method for producing a Coriolis mass flowmeter of the type incorporating a measuring tube for guiding a flowing medium, an oscillation-generating system with an oscillator serving to cause the measuring tube to oscillate, and an oscillation-sensing system with an oscillation sensor serving to capture the oscillations of the measuring tube, said method comprising the steps of providing a first companion element positioned opposite the oscillation-generating system at the same longitudinal distance on the measuring tube, providing a second companion element positioned opposite the oscillation-sensing system at the same longitudinal distance on the measuring tube, variably modifying the mass of the oscillation-generating system and the mass of the oscillation-sensing system, with the mass of the first companion element in each case selected to match the mass of the oscillation-generating system and the mass of the second companion element in each case selected to match the mass of the oscillation-sensing system, and determining for a predefined excitation frequency of the measuring tube the mass of the oscillation-generating system and, respectively, of the oscillation-sensing system at which the oscillation loss is lowest.

7. The method as in claim 6, wherein the determination of the mass of the oscillation-generating system and the oscillation-sensing system at which the oscillation loss is lowest is made by determining the mass of the oscillation-generating system and 8 the oscillation-sensing system at which the lowest oscillation amplitude is obtained at the ends of the measuring tube.

8. A Coriolis mass flowmeter incorporating a measuring tube for guiding a flowing medium, an oscillation-generating system with an oscillator serving to cause the measuring tube to oscillate, and an oscillation-sensing system with an oscillation sensor serving to capture the oscillations of the measuring tube, wherein a first companion element is provided and positioned opposite the oscillation-generating system at the same longitudinal distance on the measuring tube, a second companion element is provided and positioned opposite the oscillation-sensing system at the same longitudinal distance on the measuring tube, the mass of the first companion element matches the mass of the oscillation-generating system, the mass of the second companion element matches the mass of the oscillation-sensing system, and the first companion element and the second companion element consist exclusively of a counterweight, respectively.

9. The Coriolis mass flowmeter as in claim 8, and further including at least one additional oscillation-generating system including an oscillator for stimulating the oscillations of the measuring tube and/or an additional oscillation-sensing system including an oscillation sensor for capturing the oscillations of the measuring tube, each additional system being equipped with a companion element whose mass corresponds to the mass of the oscillation-generating system or, respectively to the mass of the oscillation-sensing system, which exclusively consists of a counterweight, and which is positioned opposite the oscillation-generating system or, respectively, the oscillation-sensing system at the same longitudinal distance on the measuring tube.

10. The Coriolis mass flowmeter as in claim 8 or 9, wherein at least one oscillalation-generating system and/or at least one oscillation-sensing system is provided with an extra weight.
